(19) United States
(12) Patent Application Publication
(10) Pub. No.: US 2026/0258185 A1
(43) Pub. Date: Sep. 3, 2026

(54) COVALENT ORGANIC FRAMEWORK MATERIAL AND PREPARATION METHOD THEREOF

(71) Applicant: Dezhou University, Dezhou City (CN)

(72) Inventors: Jianhui Xin, Dezhou City (CN); Mengxia Yan, Dezhou City (CN); Yanke Tang, Dezhou City (CN); Chunhui Li, Dezhou City (CN); Zhuqing Wang, Dezhou City (CN); Meng Li, Dezhou City (CN); Shaohong Zhang, Dezhou City (CN); Lijing Wang, Dezhou City (CN); Lei Wang, Dezhou City (CN); Rui Wang, Dezhou City (CN); Xinxin Li, Dezhou City (CN)

(21) Appl. No.: 19/080,756

(22) Filed: Mar. 14, 2025

(30) Foreign Application Priority Data
Mar. 3, 2025 (CN) 2025102399635

(51) Int. Cl. C08G 12/08

(52) U.S. Cl. CPC C08G 12/08

(57) ABSTRACT

A preparation method of a covalent organic framework material, including the following steps: using a first organic monomer and a second organic monomer as raw materials, and performing a condensation reaction under the catalytic action of a catalyst to obtain the covalent organic framework material; wherein the first organic monomer is a polyamine series; the second organic monomer is a polyaldehyde series. The covalent organic framework material provided by the invention is synthesized through catalysis by a specific catalyst provided in the invention. This specific catalyst can effectively reduce the temperature and time required for the condensation reaction, while also improving the yield of the covalent organic framework material.

### TECHNICAL FIELD

The invention relates to the technical field of organic synthesis, and in particular to a covalent organic framework material and a preparation method thereof.

### BACKGROUND ART

Covalent Organic Frameworks (COFs) are two-dimensional or three-dimensional porous crystalline organic polymer materials formed by connecting organic monomers through covalent bonds. They possess advantages such as low density, high specific surface area, regular and stable structure, uniform pore size, and easy functionalization. Since their first report in 2005, COFs have demonstrated significant application potential in fields such as gas separation, catalysis, and biomedicine.

Among the various covalent bonding methods, the imine bond (—C═N—) is a common linkage in COFs, which not only exhibits excellent chemical stability but is also compatible with various functional groups in the building units. Imine bonds can be catalyzed by Brønsted acids, transition metal Lewis acids, and organic Lewis acids, which have been widely used in the synthesis of COFs. However, Brønsted acids are corrosive to synthesis equipment and difficult to separate from the products after the reaction, thereby limiting their application in COF synthesis. As for transition metal Lewis acids, the presence of transition metals makes them environmentally unfriendly, which also restricts their use in COF synthesis. Lastly, organic Lewis acids, such as tris(pentafluorophenyl) borane, pose high safety risks, which to some extent limits their application in COF synthesis.

Based on this, how to provide a safe and highly catalytically active catalyst for COFs has become a technical problem urgently needing to be solved by those skilled in the art.

### SUMMARY OF THE INVENTION

The purpose of the invention is to provide a covalent organic framework material and a preparation method thereof. The covalent organic framework material is synthesized through catalysis by a specific catalyst provided in the invention, which exhibits high catalytic activity.

In order to achieve the above purpose, the invention provides the following technical solutions.

### First Aspect of the Invention:

a preparation method of a covalent organic framework material, including the following steps:
using a first organic monomer and a second organic monomer as raw materials, and performing a condensation reaction under the catalytic action of a catalyst to obtain the covalent organic framework material;
wherein the first organic monomer is a polyamine series;
the second organic monomer is a polyaldehyde series;
the catalyst is

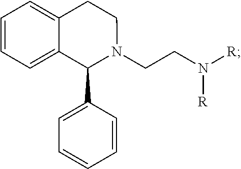

the R is —C(CH₃)₃, —C(C₆H₅)₃, —CH(CH₃)₂, or

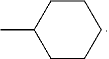

Further, the polyamine series includes but is not limited to one of

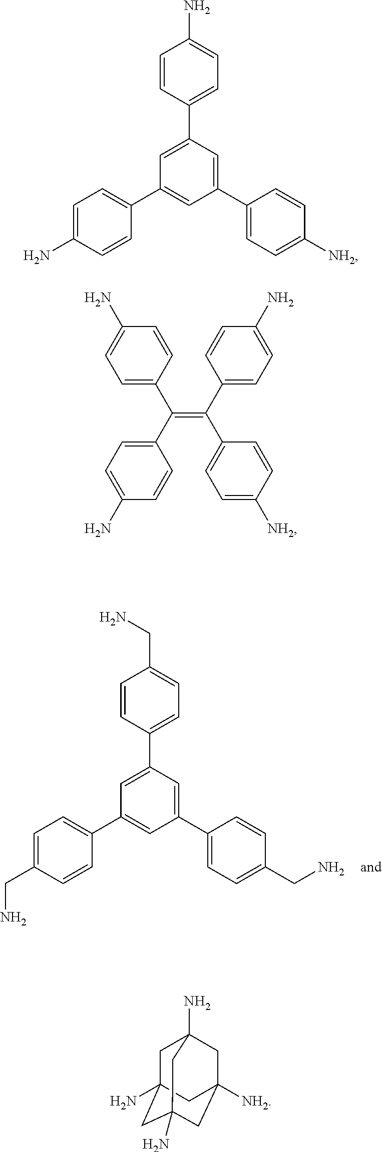

Further, the polyaldehyde series includes but is not limited to one of

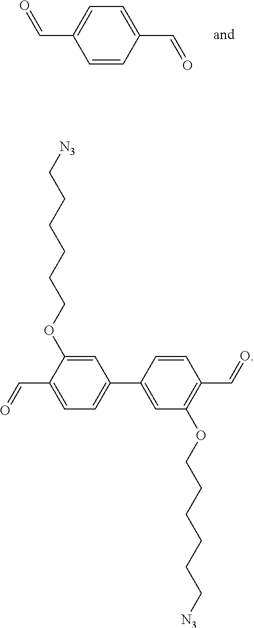 [SMILES: O=Cc1ccc(C=O)cc1 ; [N-]=[N+]=NCCCCCCOc1cc(-c2ccc(C=O)c(OCCCCCCN=[N+]=[N-])c2)ccc1C=O]

Further, the preparation method of the catalyst includes the following steps:
1) mixing phenylethylamine and benzoyl chloride in equal molar ratios and reacting at 0° C. for 1 hour in an alkaline environment to obtain a first intermediate product;
2) mixing the first intermediate product obtained in step 1) with toluene in equal molar ratios, and dehydrating and cyclizing with phosphorus oxychloride at 105° C. to obtain a second intermediate product;
3) reducing the second intermediate product with sodium borohydride to obtain a third intermediate;
4) mixing the third intermediate product obtained in step 3) and chloroacetyl chloride in equal molar ratios and reacting at 10° C. for 3 hours to obtain a fourth intermediate product;
5) mixing the fourth intermediate product obtained in step 4) and the secondary amine in equal molar ratios, and reacting at 80-120° C. for 3-5 hours to obtain a fifth intermediate product;
6) reducing the fifth intermediate product with lithium aluminum hydride to obtain a sixth intermediate product;
7) using tartaric acid to decompose the sixth intermediate product, and then alkalizing to remove the tartaric acid to obtain the catalyst.
the synthesis equation of the catalyst in the invention is as follows:

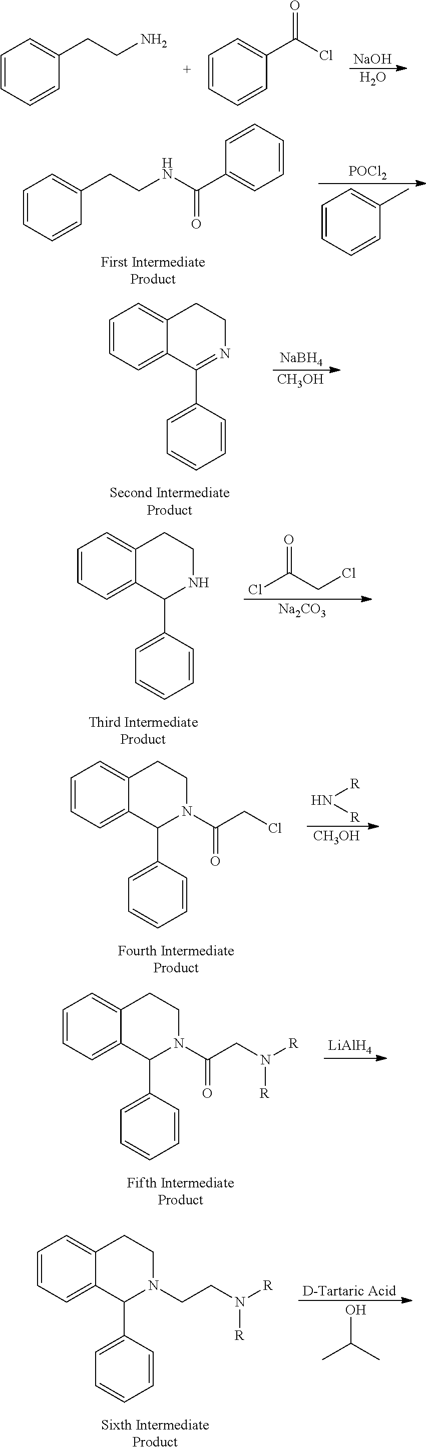

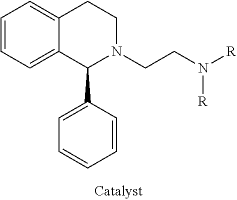

Further, the molar ratio of the first organic monomer to the second organic monomer is 1:1.2-1.5.

Further, the temperature of the condensation reaction is 40-80° C., and the time is 24-36 hours

Further, the condensation reaction adopts dimethyl sulfoxide, dichloromethane, ethanol or ethylene glycol as solvent.

### Second Aspect of the Invention:

a covalent organic framework material prepared by the preparation method of a covalent organic framework material hereinabove.

Compared with the prior art, the beneficial effects of the invention are as follows.

The covalent organic framework material provided by the invention is synthesized through catalysis by a specific catalyst provided in the invention. This specific catalyst can effectively reduce the temperature and time required for the condensation reaction, while also improving the yield of the covalent organic framework material.

### SPECIFIC EMBODIMENT OF THE INVENTION

The various exemplary embodiments of the invention are now described in detail. This detailed description should not be construed as limiting the invention but should be understood as providing a more detailed explanation of certain aspects, features, and embodiments of the invention. It should be understood that the terms used in the invention are intended to describe specific embodiments and are not intended to limit the invention.

Additionally, for numerical ranges in the invention, it should be understood that each intermediate value between the upper and lower limits of the range is also specifically disclosed. Any intermediate value within a stated range, as well as any smaller range formed between any stated value or intermediate value within the stated range and any other stated value or intermediate value within the stated range shall all fall within the invention. The upper and lower limits of these smaller ranges may be independently included or excluded from the range.

Unless otherwise specified, all technical and scientific terms used herein have the same meanings as commonly understood by those skilled in the art to which the invention pertains. Although the invention describes only preferred methods and materials, any methods and materials similar or equivalent to those described herein may also be used in the implementation or testing of the invention. All documents mentioned in this specification are incorporated by reference to disclose and describe the methods and/or materials related to those documents. In the event of any conflict with the incorporated documents, the content of this specification shall prevail.

Without departing from the scope or spirit of the invention, various modifications and changes may be made to the specific embodiments described in the specification, which will be obvious to those skilled in the art. Other embodiments derived from the description of the invention will also be obvious to those skilled in the art. The description and examples of the invention are merely illustrative.

With respect to the terms “comprising,” “including,” “having,” “containing,” and the like used herein, they are open-ended terms, meaning including but not limited to.

In the embodiment, the preparation method of the catalyst includes the following steps:
1) mixing phenylethylamine and benzoyl chloride in equal molar ratios and reacting at 0° C. for 1 hour in an alkaline environment to obtain a first intermediate product;
2) mixing the first intermediate product obtained in step 1) with toluene in equal molar ratios, and dehydrating and cyclizing with phosphorus oxychloride at 105° C. to obtain a second intermediate product;
3) reducing the second intermediate product with sodium borohydride to obtain a third intermediate;
4) mixing the third intermediate product obtained in step 3) and chloroacetyl chloride in equal molar ratios and reacting at 10° C. for 3 hours to obtain a fourth intermediate product;
5) mixing the fourth intermediate product obtained in step 4) and the secondary amine in equal molar ratios, and reacting at 80-120° C. for 3-5 hours to obtain a fifth intermediate product;
the structural formula of the secondary amine is

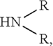

wherein R is —C(CH₃)₃, —C(C₆H₅)₃, —CH(CH₃)₂, or

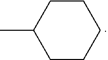

6) reducing the fifth intermediate product with lithium aluminum hydride to obtain a sixth intermediate product;
7) using tartaric acid to decompose the sixth intermediate product, and then alkalizing to remove the tartaric acid to obtain the catalyst.

In the embodiment, the preparation method of the covalent organic framework material includes the following steps:
mixing the first organic monomer and the second organic monomer according to the molar ratio of the first organic monomer to the second organic monomer being 1:1.2-1.5, selecting dimethyl sulfoxide, dichloromethane, ethanol or ethylene glycol as a solvent, and under the catalytic action of a catalyst, carrying out a condensation reaction at 40-80° C. for 24-36 hours to obtain the covalent organic framework material;
the first organic monomer is a polyamine series, and the polyamine series includes but is not limited to one of

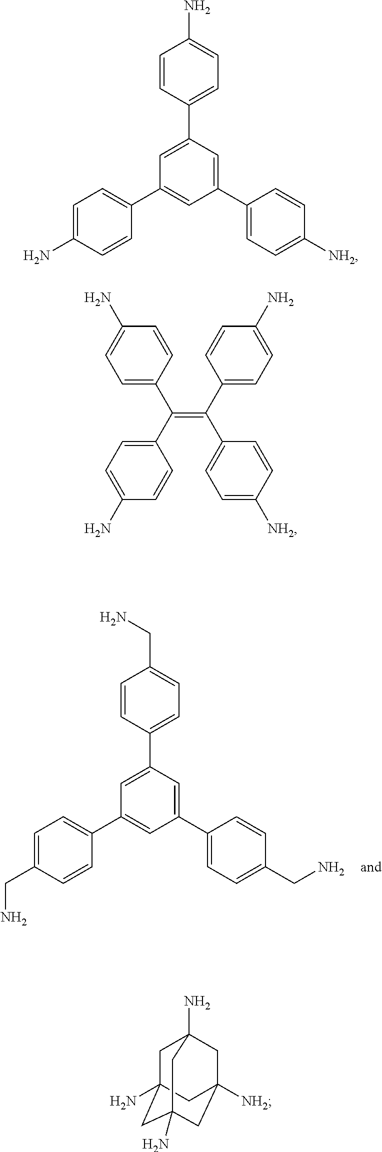

the second organic monomer is a polyaldehyde series, and the polyaldehyde series includes but is not limited to one of

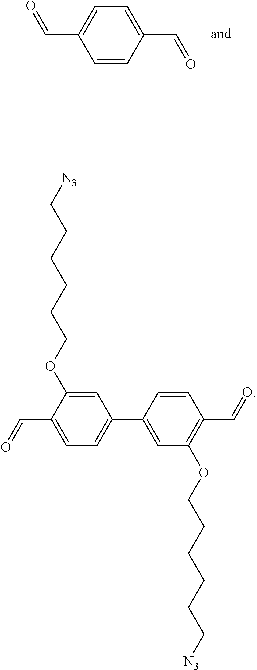 [SMILES: O=Cc1ccc(C=O)cc1 ; [N-]=[N+]=NCCCCCCOc1cc(-c2ccc(C=O)c(OCCCCCCN=[N+]=[N-])c2)ccc1C=O]

### Embodiment 1

A covalent organic framework material.

In the embodiment,

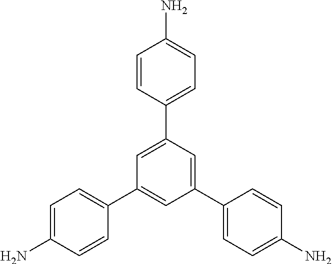 [SMILES: Nc1ccc(-c2cc(-c3ccc(N)cc3)cc(-c3ccc(N)cc3)c2)cc1]

is used as the first organic monomer,

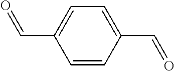

is used as the second organic monomer, and

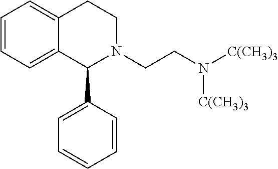 [SMILES: CC(C)(C)N(CCN1CCc2ccccc2[C@@H]1c1ccccc1)C(C)(C)C]

is used as the catalyst to synthesize the covalent organic framework material. The specific steps are as follows:
mixing the first organic monomer and the second organic monomer according to the molar ratio of the first organic monomer to the second organic monomer being 1:1.5, selecting dimethyl sulfoxide a solvent, and under the catalytic action of a catalyst, carrying out a condensation reaction at 50° C. for 24 hours to obtain the covalent organic framework material.

It has been verified that in Embodiment 1, the covalent organic framework material with a yield of 23.7% is successfully prepared.

### Comparative Embodiment 1

A covalent organic framework material.

It is the same as Embodiment 1, except that the addition of catalyst is omitted.

It has been verified that in Comparative Embodiment 1, the covalent organic framework material cannot be prepared, but by increasing the temperature to 170° C. and extending the time to 5 days, the covalent organic framework material can be prepared with a yield of 19.5%. It can be seen that the catalyst provided in Embodiment 1 can effectively reduce the temperature and time of the condensation reaction and increase the yield of the covalent organic framework material.

### Embodiment 2

A covalent organic framework material.

In the embodiment,

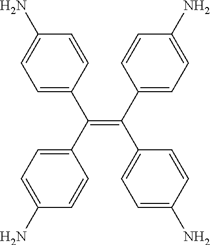 [SMILES: Nc1ccc(C(=C(c2ccc(N)cc2)c2ccc(N)cc2)c2ccc(N)cc2)cc1]

is used as the first organic monomer,

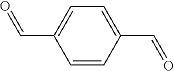

is used as the second organic monomer, and

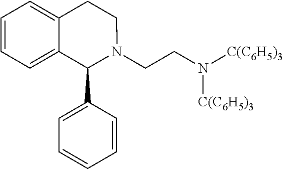

is used as the catalyst to synthesize the covalent organic framework material. The specific steps are as follows:
mixing the first organic monomer and the second organic monomer according to the molar ratio of the first organic monomer to the second organic monomer being 1:1.5, selecting dimethyl sulfoxide a solvent, and under the catalytic action of a catalyst, carrying out a condensation reaction at 70° C. for 30 hours to obtain the covalent organic framework material.

It has been verified that in Embodiment 2, the covalent organic framework material with a yield of 21.9% is successfully prepared.

### Comparative Embodiment 2

A covalent organic framework material.

It is the same as Embodiment 2, except that the addition of catalyst is omitted.

It has been verified that in Comparative Embodiment 2, the covalent organic framework material cannot be prepared, but by increasing the temperature to 230° C. and extending the time to 4 days, the covalent organic framework material can be prepared with a yield of 15.3%. It can be seen that the catalyst provided in Embodiment 2 can effectively reduce the temperature and time of the condensation reaction and increase the yield of the covalent organic framework material.

### Embodiment 3

A covalent organic framework material.

In the embodiment,

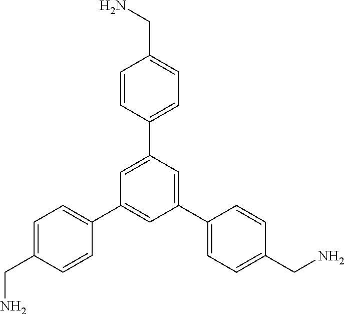 [SMILES: NCc1ccc(-c2cc(-c3ccc(CN)cc3)cc(-c3ccc(CN)cc3)c2)cc1]

is used as the first organic monomer,

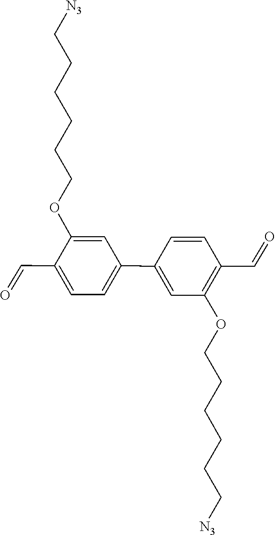 [SMILES: [N-]=[N+]=NCCCCCCOc1cc(-c2ccc(C=O)c(OCCCCCCN=[N+]=[N-])c2)ccc1C=O]

is used as the second organic monomer, and

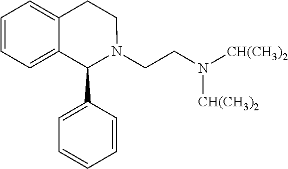 [SMILES: CC(C)N(CCN1CCc2ccccc2[C@@H]1c1ccccc1)C(C)C]

is used as the catalyst to synthesize the covalent organic framework material. The specific steps are as follows:
mixing the first organic monomer and the second organic monomer according to the molar ratio of the first organic monomer to the second organic monomer being 1:1.3, selecting dimethyl sulfoxide a solvent, and under the catalytic action of a catalyst, carrying out a condensation reaction at 80° C. for 36 hours to obtain the covalent organic framework material.

It has been verified that in Embodiment 3, the covalent organic framework material with a yield of 25.4% is successfully prepared.

### Comparative Embodiment 3

A covalent organic framework material.

It is the same as Embodiment 3, except that the addition of catalyst is omitted.

It has been verified that in Comparative Embodiment 3, the covalent organic framework material cannot be prepared, but by increasing the temperature to 160° C. and extending the time to 8 days, the covalent organic framework material can be prepared with a yield of 13.6%. It can be seen that the catalyst provided in Embodiment 3 can effectively reduce the temperature and time of the condensation reaction and increase the yield of the covalent organic framework material.

### Embodiment 4

A covalent organic framework material.

In the embodiment,

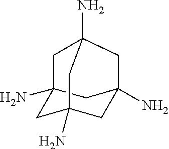 [SMILES: NC12CC3(N)CC(N)(C1)CC(N)(C2)C3]

is used as the first organic monomer,

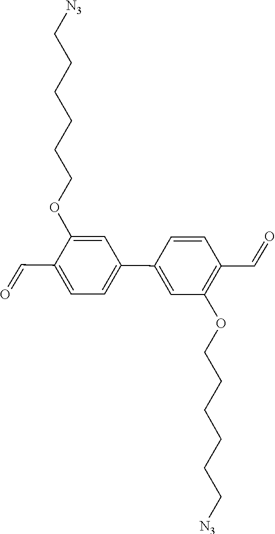 [SMILES: [N-]=[N+]=NCCCCCCOc1cc(-c2ccc(C=O)c(OCCCCCCN=[N+]=[N-])c2)ccc1C=O]

is used as the second organic monomer, and

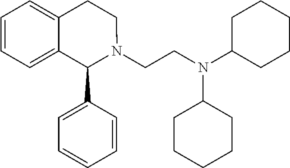 [SMILES: c1ccc([C@H]2c3ccccc3CCN2CCN(C2CCCCC2)C2CCCCC2)cc1]

is used as the catalyst to synthesize the covalent organic framework material. The specific steps are as follows:
mixing the first organic monomer and the second organic monomer according to the molar ratio of the first organic monomer to the second organic monomer being 1:1.52, selecting dimethyl sulfoxide a solvent, and under the catalytic action of a catalyst, carrying out a condensation reaction at 40° C. for 36 hours to obtain the covalent organic framework material.

It has been verified that in Embodiment 4, the covalent organic framework material with a yield of 19.7% is successfully prepared.

### Comparative Embodiment 4

A covalent organic framework material.

It is the same as Embodiment 4, except that the addition of catalyst is omitted.

It has been verified that in Comparative Embodiment 4, the covalent organic framework material cannot be prepared, but by increasing the temperature to 290° C. and extending the time to 6 days, the covalent organic framework material can be prepared with a yield of 7.5%. It can be seen that the catalyst provided in Embodiment 1 can effectively reduce the temperature and time of the condensation reaction and increase the yield of the covalent organic framework material.

Finally, it should be noted that the above embodiments are only used to illustrate the technical solutions of the invention rather than to limit it. Although the invention has been described in detail with reference to the above embodiments, those of ordinary skill in the art should understand that the specific implementation methods of the invention can still be modified or replaced by equivalents, and any modifications or equivalent replacements that do not depart from the spirit and scope of the invention should be covered within the protection scope of the claims of the invention.

1. A preparation method of a covalent organic framework material, including the following steps:
using a first organic monomer and a second organic monomer as raw materials, and performing a condensation reaction under the catalytic action of a catalyst to obtain the covalent organic framework material;
wherein the first organic monomer is a polyamine series;
the second organic monomer is a polyaldehyde series;
the catalyst is 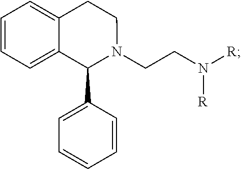
the R is —C(CH₃)₃, —C(C₆H₅)₃, —CH(CH₃)₂, or

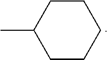

2. The preparation method of a covalent organic framework material of claim 1, wherein the polyamine series includes but is not limited to one of

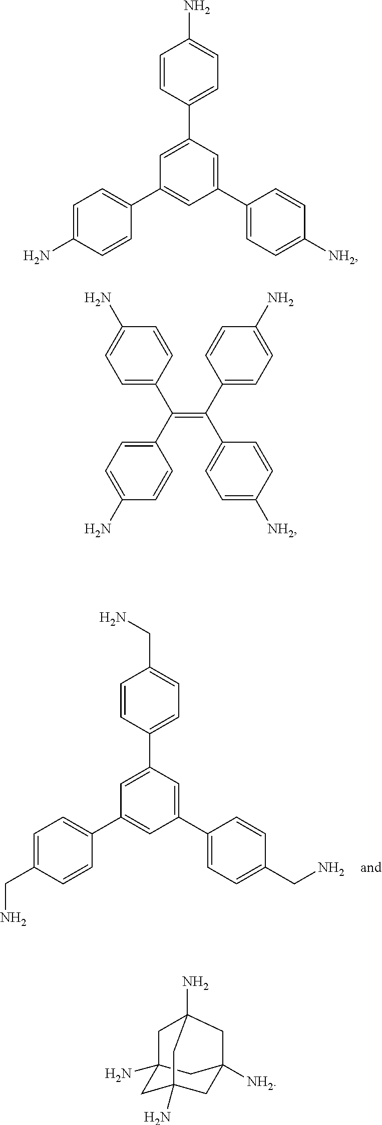

3. The preparation method of a covalent organic framework material of claim 1, wherein the polyaldehyde series includes but is not limited to one of

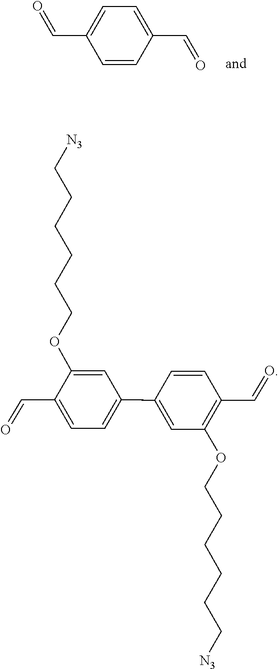 [SMILES: O=Cc1ccc(C=O)cc1 ; [N-]=[N+]=NCCCCCCOc1cc(-c2ccc(C=O)c(OCCCCCCN=[N+]=[N-])c2)ccc1C=O]

4. The preparation method of a covalent organic framework material of claim 1, wherein the preparation method of the catalyst includes the following steps:
1) mixing phenylethylamine and benzoyl chloride in equal molar ratios and reacting at 0° C. for 1 hour in an alkaline environment to obtain a first intermediate product;
2) mixing the first intermediate product obtained in step 1) with toluene in equal molar ratios, and dehydrating and cyclizing with phosphorus oxychloride at 105° C. to obtain a second intermediate product;
3) reducing the second intermediate product with sodium borohydride to obtain a third intermediate;
4) mixing the third intermediate product obtained in step 3) and chloroacetyl chloride in equal molar ratios and reacting at 10° C. for 3 hours to obtain a fourth intermediate product;
5) mixing the fourth intermediate product obtained in step 4) and the secondary amine in equal molar ratios, and reacting at 80-120° C. for 3-5 hours to obtain a fifth intermediate product;
6) reducing the fifth intermediate product with lithium aluminum hydride to obtain a sixth intermediate product;
7) using tartaric acid to decompose the sixth intermediate product, and then alkalizing to remove the tartaric acid to obtain the catalyst.

5. The preparation method of a covalent organic framework material of claim 1, wherein the molar ratio of the first organic monomer to the second organic monomer is 1:1.2-1.5.

6. The preparation method of a covalent organic framework material of claim 1, wherein the temperature of the condensation reaction is 40-80° C., and the time is 24-36 hours.

7. The preparation method of a covalent organic framework material of claim 1, wherein the condensation reaction adopts dimethyl sulfoxide, dichloromethane, ethanol or ethylene glycol as solvent.

8. A covalent organic framework material prepared by the preparation method of a covalent organic framework material of claim 1.
